(19) United States
(12) Patent Application Publication
(10) Pub. No.: US 2008/0144111 A1
(43) Pub. Date: Jun. 19, 2008

(54) Generating random and density controllable dot patterns method

(76) Inventors: Cheng-Tai Lee, Tainan Hsien (TW); Jee-Gong Chang, Tainan Hsien (TW); Yu-Bin Fang, Tainan Hsien (TW); Chi-Chuan Hwang, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/583,821

(22) Filed: Oct. 20, 2006

(51) Int. Cl. G06K 15/00

(52) U.S. Cl. 358/3.1; 358/3.19

(57) ABSTRACT

A method to generate random and density controllable dot patterns includes steps of dividing a 2D domain into multiple cell units; determining dot density in each cell; creating at random initial location of dots in each cell; solving the force operation cut radius of the dot; setting up a residual force; solving the force control parameter in the cell; performing the force operation for the cell; making the dots in the cell to achieve balanced positions after repeated operation; and completing the generation of a dot-pattern within a 2D domain.

### BACKGROUND OF THE INVENTION

(a) Field of the Invention

The present invention relates to a method to generate random and density controllable dot patterns, and more particularly, to one that employs algorithm of molecular-dynamics theories to execute random movement of dots distributed on a 2D plane so that the density of the dots thereon is controllable and the dot-to-dot relative positions are distributed at random.

(b) Description of the Prior Art

To liquid-crystal display (LCD) backlight modules generally available in the market today, the arrangement of dot-patterns or the optical micro-structural arrangement on light guide when featuring random distribution are more capable of avoiding the presence of unpredictable Moire; and how to provide uniform luminance of the light illuminant surface of the light guide, the control of the density distribution of dots become the key issue in the design. The dispersed pattern technology commonly applied at present is applicable to the light guide in a light emitting liquid crystal display or an astigmatic sheet as taught in U.S. Pat. Nos. 6,754,419 and 6,865,325. However, the algorithm of either patent cited fails to achieve highly uniform irregular distribution within a given area for the distribution of dots, or to draw forth control parameters with a specific type of force-function resulting in further failure to achieve smooth distribution of dots with force control parameter for liquid crystal boards of different dot densities. Therefore, both patents fail to achieve the optimal use by their dispersed pattern technologies as disclosed.

### SUMMARY OF THE INVENTION

The primary purpose of the present invention is to provide a method to generate random 2D dot-patterns with density controllable, and the method includes the following steps:

A. dividing a 2D domain into multiple cell units;

B. determining dot density in each cell;

C. creating at random initial location of dots in each cell;

D. solving the force operation cut radius of the dot by employing the following equation:

$${r}_{cut} = l \sqrt{\frac{{\sum }_{k}^{m} {\overline{r}}_{k}^{2}}{D \cdot {a}_{c} \cdot m}} ;$$

E. setting up a residual force;

F. solving the force control parameter in the cell by employing the following equation:

$${s}_{c} = \frac{- ln {f}_{re}}{\vert {r}_{ij} \vert} ;$$

G. performing the force operation for the cell by employing the following equation:

$$f ( {r}_{ij} ) = \{ \begin{matrix}\frac{{r}_{ij}}{\vert {r}_{ij} \vert} \cdot {e}^{- ( {r}_{ij} \cdot {s}_{c} )} , {r}_{ij} \leq {r}_{cut} \\ 0 , {r}_{ij} > {r}_{cut}\end{matrix} ;$$

H. making the dots in the cell to achieve balanced positions after repeated operation; and

I. completing generating dot-pattern within a 2D domain.

Wherein, the cell is a square; and the setting of residual force is 0.001.

Preferably the present invention is a light guide designed by employing the method to generate random 2D dot-patterns with density controllable as described above.

Preferably the present invention is a backlight module for the light guide designed by employing the method to generate random 2D dot-patterns with density controllable as described above.

Preferably the present invention is a liquid crystal display designed by employing the method to generate random 2D dot-patterns with density controllable as described above.

Preferably the present invention is a dot-pattern designed by employing the method to generate random 2D dot-patterns with density controllable as described above.

Preferably the present invention is a computer readable storage medium containing the programs of the method to generate random 2D dot-patterns with density controllable as described above.

Preferably the present invention is a system of the method to generate random 2D dot-patterns with density controllable as described above.

The prevent invention provides the following advantages:

1. The present invention introduces the concept of variable cut radius, which in molecular dynamics is a method to save the operation amount of a computer. In the present invention, the variable cut radius is deemed as a method of motion space with a specific dot for the distribution of dots within a given domain to attain irregular distribution that is highly uniform.

2. The present invention draws forth force control parameter by specific type of force function and employs repulsive force model of an exponential function to lead to a force control parameter for the control of the force distribution curve so that the cut radius of each dot in each cell becomes variable by changing the dot-to-dot operation relation through modulation of the parameter.

3. The present invention realizes smooth distribution of dots with the force control parameter. In processing the operation of the dots distribution of any two abutted cells containing different numbers of dot, force control parameters each of the abutted cells located on the boundary of the cell are taken into consideration to attain the optimal distribution locations for the dots distribution to achieve smooth changes.

4. The present invention is capable of providing highly uniform distribution, i.e., higher capability for the irregular uniform distribution, and is free of prescribing the upper limit of the number of dots within the pre-designated statistical region.

5. The present invention yields high filling rate. The filling rate is solved by having the product of the real coverage of the circular dots within a given domain multiplied by the total number of dots contained in the domain to be divided by the area of the domain. Should the number of dots designed for a single cell is not greater than 1000, a filling rate not less than 60% is attainable for all the dots without overlapping from one another. Should this efficacy be converted using the method to solve filling rate as disclosed in the prior art (i.e., Taiwan Patent No. 1224698), the filling rate of dots distribution of the present invention is as high as 76%.

### BRIEF DESCRIPTION OF THE DRAWINGS

FIG. 1 is a flow chart showing the creation of a system model in a preferred embodiment of the present invention.

FIG. 2 is a schematic view showing the reaction area of dots in the preferred embodiment of the present invention.

FIG. 3 is a schematic view showing a force function in the preferred embodiment of the present invention.

FIG. 4 is a flow chart showing an algorithm in the preferred embodiment of the present invention.

FIG. 5 is a schematic view showing force reaction of dots on the boundary in the preferred embodiment of the present invention.

FIG. 6 is a schematic view showing the uniform distribution statistics of dots distribution at random in the preferred embodiment of the present invention.

### DETAILED DESCRIPTION OF THE PREFERRED EMBODIMENTS

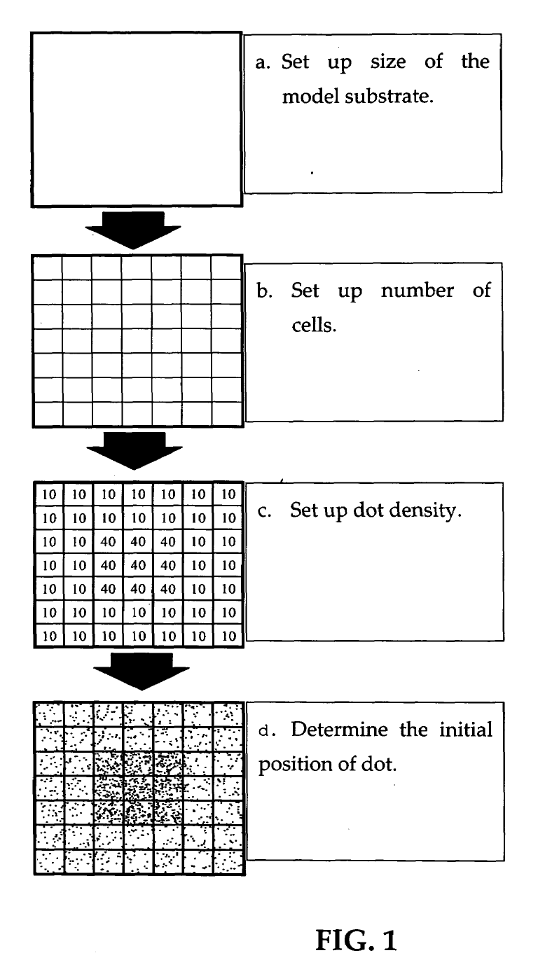

Referring to FIG. 1, a system model of the present invention is created in the following process:

a. Set up the dimension of the substrate for the model.

b. Set up the number of cells: in doing so, the entire dots distribution 2D is divided into a plane by the arrangement of multiple square cells.

c. Set up dot density (%) before deciding on the dot filling density (D) in each cell. The filling density (D) is solved by employing Equation (1) as follows:

$$D = \frac{{A}_{dot}}{{A}_{cell}} = \frac{{\sum }_{k}^{m} π \cdot {\overline{r}}_{k}^{2}}{{A}_{cell}} \qquad ( 1 )$$

where, m represents the total number of dots within a cell; and r̅ₖ represents the radius of each dot.

d. Determine the initial position of dot: when the density for each cell is determined, the number of dots in that cell is also determined; and the initial position of dot in each cell is then determined by fuzzy at random.

In the force operation relation adopted according to the algorithm proposed by the present invention, the perimeter of the substrate must be set up as a periodical boundary to achieve balanced conditions since there is only the repulsive force relation existing among dots.

In the present invention, motion of an atom is considered as that of a dot as illustrated in Equation (2) below according to is the methodology of molecular dynamics while observing the Newton's Second Law of Motion:

$$m \frac{{d}^{2} {r}_{i}}{d {t}^{2}} + c \frac{d {r}_{i}}{d t} = {\sum }_{j}^{n} {f}_{ij} ( {r}_{i} , {r}_{j} ) \qquad ( 2 )$$

where, rᵢ is the position of i^{th} dot; m is the mass of the dot; c is the damping term of the motion system; and fᵢⱼ is the force between Dot i and its adjacent Dot j. In the concept of molecular dynamics, a certain energy relation existing among atoms known as the potential energy φᵢⱼ(rᵢⱼ), and the potential energy is a function of the relative distance among atoms. Therefore, force among atoms may be solved by differential of the distance as illustrated in Equation (3) below:

$$\frac{d {φ}_{ij}}{d r} = {f}_{ij} ( {r}_{i} , {r}_{j} ) \qquad ( 3 )$$

By incorporating both Equations (2) and (3), it is found that a motion status of a dot is a result of a force applied to it from its adjacent dots. When the total force applied to that dot is at its minimum, it is safe to say that that dot has attained its balanced position in the system and starts to execute mild regular oscillation.

Perform integration for Equation (2) with a range of micro time lag Δt=t−t₀, to solve the position of a dot after a micro time lag as illustrated in Equation (4) below:

$${r}_{i} ( t ) = {r}_{i} ( {t}_{0} ) + \frac{1}{c} {\int }_{0}^{t} d τ {F}_{i} ( τ ) \{ 1 - exp [ - \frac{c ( t - τ )}{m} ] \} \qquad ( 4 )$$

where, Fᵢ is the total force that Dot i is subject to, i.e.,

$${F}_{i} = {\sum }_{j = 1}^{n} {f}_{ij}$$

Whereas the present invention focuses on the randomized position of the dot distribution on 2D plane, the mass relation in the real physical system can be ignored. Therefore, Equation (4) is simplified with the assumption of

$$\frac{c}{m} \to ∞$$

into a Differential Equation (5) as follows:

$${r}_{i} ( t + Δ t ) = {r}_{i} ( t ) + \frac{1}{c} Δ {tF}_{i} ( t ) \qquad ( 5 )$$

Equation (5) is related to one that predicts the position. That is, the position for each dot at the next step of time is the corrected position of the current step of time solved. However, the damper coefficient, C, is also a determinant factor other than the amount of the total force externally applied to the dot that affects the correction of the dot at each unit step of time.

Step of time Δt in the computer operation plays a role of each operation loop. Once the value of C gets greater, Δt/c can be seen as such that the correction in each operation loop tends to get smaller; on the contrary, the smaller the value of C is, the greater correction gets.

The force operation equation applied for the term of exponent in the present invention is Equation (6)

$$f ( {r}_{ij} ) = \{ \begin{matrix}\frac{{r}_{ij}}{\vert {r}_{ij} \vert} \cdot {e}^{- ( {r}_{ij} \cdot {s}_{c} )} , {r}_{ij} \leq {r}_{cut} \\ 0 , {r}_{ij} > {r}_{cut}\end{matrix} \qquad ( 6 )$$

where, rᵢⱼ is a vector representing relative distance among dots; S_{c} is a force control parameter for each dot; and r_{cut} is a force operation cut radius of dot.

A parameter Aᵣ is defined to represent the reaction area of each dot and extendable to its adjacent cell before explaining how to determine the force operation cut radius of the dot. In the present invention, conditions are set up with the minimal reaction area for analysis as shown in Equation (7):

$${A}_{r\_min} = \frac{{A}_{cell}}{{a}_{c} \cdot m} \qquad ( 7 )$$

where, a_{c} is the ratio parameter and is set at 1; and m represents the number of dots within a cell.

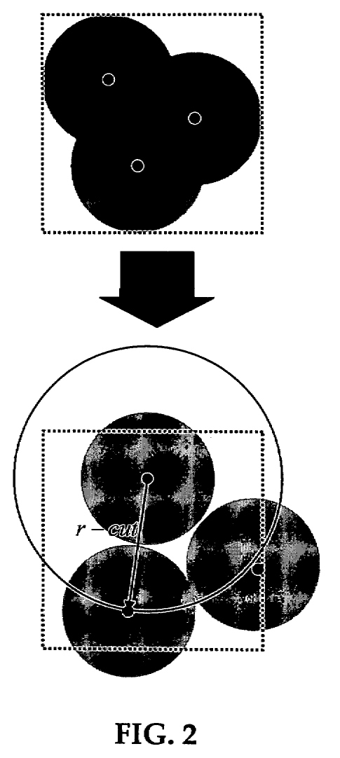

As illustrated in FIG. 2, if a cell contains three dots and the total area of the dots is equal to that of the cell, partial overlapped area of the dots must take place. To avoid overlapping, the minimal distance among dots has to be two times over the radius of any current dot. Accordingly, the distance relation is set as r_{cut} of the dot within the cell that can be solved by Equation (8) as follows:

$${r}_{cut} = l \sqrt{\frac{{\sum }_{k}^{m} {\overline{r}}_{k}^{2}}{D \cdot {a}_{c} \cdot m}} \qquad ( 8 )$$

where l is the ratio factor.

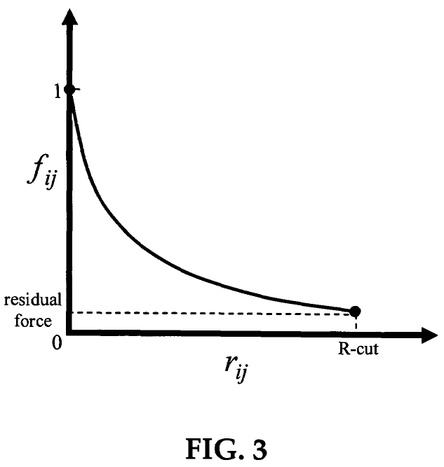

The primary reason to select the force operation equation of the exponent term is for its simple form of function to easily solve the force control parameter. The residual force, fᵣₑ must be determined before solving the force control parameter. The value selected for the residual force is directly reacted in the size of the resultant force each dot is subject to in each operation step. Although assignment of a greater value to fᵣₑ pays the greater correction of the position in each operation step so that the balanced position can be attained for the dot in shorter time, the entire operation time increases instead since the greater value of position correction means frequent access to and from the cell boundary to warrant continuous performance of Verlet algorithm. 0.001 is proposed for fᵣₑ in the present invention that provides more efficiency in the course of operation. The pattern plotted in FIG. 3 is related to one of dot-to-dot force operation function; wherein, the amount of force reaction at the position of the length r_{cut} is the very residual force.

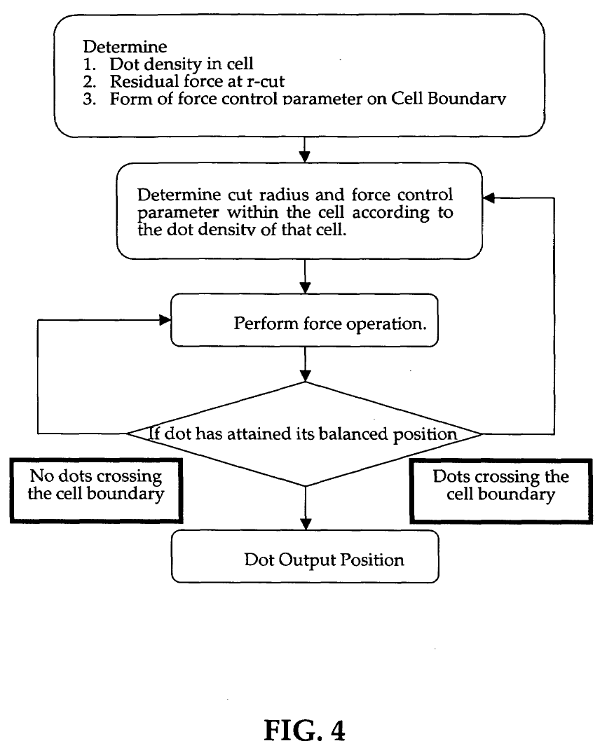

When both the residual force and the cut radius are finalized, the force control parameter is determined for each cell by employing Equation (9). The primary purpose of the force control parameter is to serve as a modulation technique in the process of the force operation of the dot in the adjacent cell.

$${s}_{c} = \frac{- ln {f}_{re}}{\vert {r}_{ij} \vert} \qquad ( 9 )$$

where |rᵢⱼ|=r_{cut} . All parameters required in the entire process have been determined and the algorithm is described as follows.

Whereas the present invention focuses on how to generate dot-pattern that is random, consistently distributed with its density controllable; the distribution position of dot is the ultimate results desired. FIG. 4 illustrates the operation process that commencing from solving parameters needed for the operation process by taking advantage of the mathematic structure as described above before proceeding to force operation process until the dot-pattern is availed as desired to end up the operation of the loop at the position of the output dot.

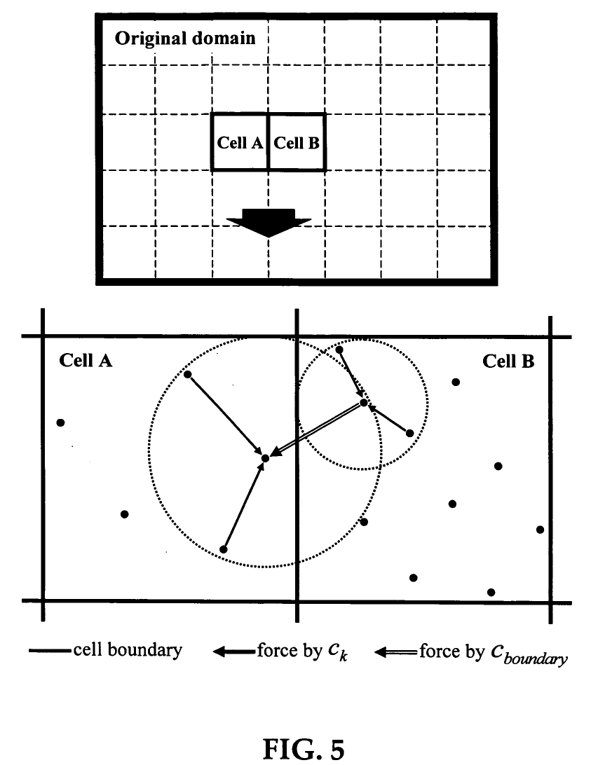

When the dot density in the adjacent cell varies, the cut radius and force control parameters applicable to that cell also differ. Judging from Equations (8) and (9), it is found that when r_{cut} varies, the resultant force control parameter also differs. Proper command of the force control parameter will create a transition region featuring a smooth density distribution on the boundary of the adjacent cell of different dot density. FIG. 5 illustrates the process of the force operation for the dot crossing the cell boundary.

As illustrated in FIG. 5, the dot r_{cut} of Cell A with lower dot density is greater than that of Cell B; therefore, the dot in the r_{cut} (broken line) of Dot A1 will exert repulsive force against A1. A1 appears to be subject to two different types of repulsive force and the force control parameter introduced determines the primary variation between the two types of repulsive force. The force applied from the dot in the same cell on A1 (dark line with arrow) is solved by substituting with force control parameter S_{c} of Cell A in Equation (6). Dot B1 in Cell B will apply a certain force, but the force is not determined by substitution with Cell B force control parameter; instead, Equation (10) is employed to determine the force operation parameter when the dot crosses the boundary:

$${s}_{c\_b} = \frac{{s}_{c\_cell A} + {s}_{c\_cell B}}{2} \qquad ( 10 )$$

Equation (10) forthwith takes the arithmetic mean of force control parameters of two abutted Cells becomes the parameter to be introduced into Equation (6) for solving the force taking place on the cell boundary (dotted line with arrow).

Since the dot density of Cell B is higher, the r_{cut} of Dot B1 becomes smaller. Therefore, Dot B1 is subject only to the force applied by the other two dots within the same cell without being affected by A1. That is, the action between A1 and B1 is one-way nature, not such as described for the force among atoms in the orthodontic molecular dynamics that force between two atoms takes place by opposite corners.

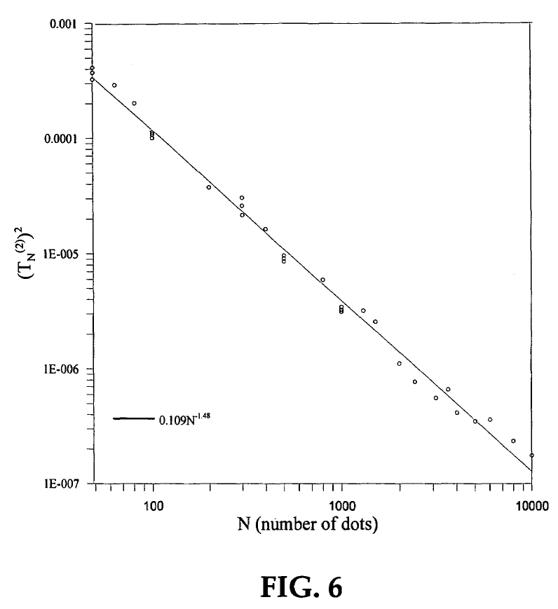

FIG. 6 shows the results of uniform distribution of random distribution of dots in different numbers within a 3*3 pre-designated cell region under different number of dots according to the statistics compiled by employing Equation (2). Within a pre-designated region, the value of uniform distribution of random distribution varies depending on the number of dots contained in that region though it must satisfy Equation (1).

What is claimed is:

1. A method to generate random and density controllable dot patterns including the following steps:
A. dividing a 2D domain into multiple cell units;
B. determining dot density in each cell;
C. creating at random initial location of dots in each cell;
D. solving the force operation cut radius of the dot by employing the following equation;
$${r}_{cut} = l \sqrt{\frac{{\sum }_{k}^{m} {\overline{r}}_{k}^{2}}{D \cdot {a}_{c} \cdot m}}$$
E. setting up a residual force;
F. solving the force control parameter in the cell by employing the following equation;
$${s}_{c} = \frac{- ln {f}_{re}}{\vert {r}_{ij} \vert}$$
G. performing the force operation for the cell by employing the following equation;
$$f ( {r}_{ij} ) = \{ \begin{matrix}\frac{{r}_{ij}}{\vert {r}_{ij} \vert} \cdot {e}^{- ( {r}_{ij} \cdot {s}_{c} )} , {r}_{ij} \leq {r}_{cut} \\ 0 , {r}_{ij} > {r}_{cut}\end{matrix} .$$
H. making the dots in the cell to achieve balanced positions after repeated operation;
I. completing generating dot-pattern within a 2D s domain;
wherein, rᵢⱼ is a vector representing relative distance among dots; S_{c} is the force control parameter for each dot; r_{cut} is the force operation cut radius of the dot; l is ratio factor; m is total number of dots in a cell; r̅ₖ is the radius of each dot; fᵣₑ is residual force; and a_{c} is ratio parameter.

2. The method to generate random and density controllable dot patterns as claimed in claim 1, wherein each cell is a square.

3. The method to generate random and density controllable dot patterns as claimed in claim 1, wherein the setting of the residual force is 0.001.

4. A light guide that is designed by employing the method to generate random and density controllable dot patterns as claimed in claim 1.

5. A backlight module of a light guide that is designed by employing the method to generate random and density controllable dot patterns as claimed in claim 1.

6. A liquid crystal display that is designed by employing the method to generate random and density controllable dot patterns as claimed in claim 1.

7. A dot pattern that is designed by employing the method to generate random and density controllable dot patterns as claimed in claim 1.

8. A computer readable storage medium containing the method to generate random and density controllable dot patterns as claimed in claim 1.

9. A system that executes the method to generate random and density controllable dot patterns as claimed in claim 1.
